(19) United States
(12) Patent Application Publication
(10) Pub. No.: US 2008/0209417 A1
(43) Pub. Date: Aug. 28, 2008

(54) Method and system of project management and task collaboration over instant messenger

(76) Inventor: Gabriel Jakobson, Las Vegas, NV (US)

Correspondence Address: PetNote LLC;Attn:Steven Rueben, 3862 Ruskin Street, Las Vegas, NV, 89147, US

(21) Appl. No.: 11/709,572

(22) Filed: Feb. 22, 2007

(51) Int. Cl. G06F 9/46; G06F 15/16

(52) U.S. Cl. 718/100

(57) ABSTRACT

A method and apparatus for allowing for the exchange of tasks, over an instant messenger (“IM”) infrastructure, are disclosed. An IM application, running on an electronic device, may allow creation, assigning, tracking, viewing, exporting, importing and managing tasks. IM applications may include, but not be limited to, stand-alone applications, browser plug-ins, on-screen widgets and gadgets, PDA and cellular phone modules, server-sided applications rendered on a client machine, etc. Personal Information Management (“PIM”) applications may use IM infrastructures to exchange of tasks or task information. Project management applications (“PMA”) may be used to define projects, containing tasks with complex sets of rules and inter-dependencies, and leverage IM networks for disseminating these projects and tasks among users. Tasks exchanged on an IM network may be imported into PMAs and PIMs. Tasks may be exchanged in a peer-to-peer IM network, which may span multiple IM service providers. Tasks may be transported in XML data structures which may contain data pertaining to users for whom tasks are intended, the progress made on tasks, documents attached to tasks, etc. User roles and privileges may be defined within tasks structures such that some users are the assignees of a task, while other users may only view task progress and be notified of milestones as tasks are worked on. Users may create task groups and communities, allowing them to control who may assign tasks to members of the group.

### FIELD OF INVENTION

The present invention relates to the use of instant messaging over electronic devices. More particularly, the present invention relates to adding and incorporating a framework for a peer-to-peer exchange of tasks and projects to instant messenger services, achieving better user collaboration and enhancing social computing.

### BACKGROUND OF THE INVENTION

Instant messaging (or “IM”) has become a popular way for many people world-wide to exchange messages in real time. Examples of popular instant messenger services include Qnext®, Windows Live Messenger®, AOL Instant Messenger®, Yahoo! Messenger®, Skype®, Google Talk®, .NET Messenger Service®, Jabber®, QQ®, Excite/Pal iChat® and ICQ®. Instant messaging applications use various protocols to allow users, using client-sided applications, to connect to servers which broker the messaging communications between users. Strategic partnerships among IM service providers (e.g. AOL® and Google®, Yahoo!® and Microsoft®, etc.), the use of open and/or common communication protocols (e.g. SIP/SIMPLE, XMPP, etc.) and IM clients that are able to communication with multiple IM services (e.g. iChat, Trillian, Gaim, Fire, Proteus, Miranda IM, Adium, Everybuddy, Ayttm, Kopete, Centericq, BitlBee, Windows Messenger, IMVITE, etc.) allow users connected to one service to exchange information with users using other IM services.

Instant messenger users can add other users—often people with whom they converse frequently—to a contact list. Instant messaging applications often offer an “offline” feature, which allows users to send messages to users who are not actively on line. (i.e. are not currently signed in to the instant messaging services and are not in a “chat session”). Such IM messages are often queued up on the servers brokering the instand messaging transactions. Once a user, who is the intended recepient of a message, logs in to the messaging service, their client messaging software may check for any offline messages and display any messages sent to them while they were offline. Many instant messaging applications offer a history feature, which allows a user to review a recording of their chat conversation with another user. While instant messaging applications may generally allow users to exchange various forms of content, such as text, graphics, audio and video, they lack the capability for assigning and tracking tasks among users.

Conventional task management applications, such as personalized information management (“PIM”) applications (e.g. Microsoft Outlook®, BlackBerry® or Palm® desktop applications, TaskSolutions CheckList™, Lotus Notes®, etc.) PIM applications allow a user to organize and track their own tasks. In some cases, these applications interface with an external system-of-record, such as Microsoft Exchange®. These applications may also interface with PDAs (personal digital assistants) or smart phones, creating a continuum between a user's hand-held device and a back office system of record. In a typical fashion, a user may create a task in an application such as Microsoft Outlook®, interfacing with a back-office server such as Microsoft Exchange®. When the user synchronizes their PDA with the Exchange® server, that task shows on their PDA or smart phone. Once they have marked that task as “complete” on their device, and synchronized it back with the Exchange® server, the master record of that task is marked as complete. Any other application or device interfacing with the user's account on that Exchange® server will display the correct status of that task. Various features in these tools may allow user to define a task, send it to another user who, in turn, may accept or reject it; and, receive notification when the recipient has executed the task. This may work as long as both sender and recipient are on the same platform, in the same physical or virtual environment. Platform compatibility issues, portability issues, corporate security policies and lack of a common protocol are among the factors inhibiting an effective way for a heterogeneous group of users to delegate and track tasks.

Project management applications (“PMA”) (e.g. Microsoft Project®) are used to define projects, containing tasks with complex sets of rules and inter-dependencies, and assign tasks to various people. PMA systems of record may be inaccessible to users designated as task owners for a variety of common reasons: network inaccessibility, security challenges, lack of standard interfaces and protocols, etc. Task owners defined in a PMA project often resort to communicating their completion of tasks to a person updating the PMA using indirect means such as email, IM messages, phone, etc. The process is inefficient and error-prone.

While IM products have bridged many of the communication challenges among heterogeneous users with incompatible systems of record, they lack a framework for delegating and tracking tasks. User A may type a task, in the form of a text message over IM, to User B. At present, User B does not have a way of importing that text message into their system of record, such as a PMA or PIM, as an official task (a task typically has numerous attributes in addition to the text of the task, such as the name of person issuing the task, the task's priority, a completion deadline, etc.) Groups of IM users have no effective means of assigning tasks within a group or community and/or tracking the progress of such tasks using PIM or PMA applications.

### DESCRIPTION OF THE DRAWINGS

For a more complete understanding of the present invention and further advantages thereof, references are now made to the following Detailed Description, taken in conjunction with the drawings, in which:

FIG. 1. is a generalized block diagram illustrating the interaction between a project management application and an instant messenger application, according to one embodiment of the present invention.

FIG. 2. is a generalized block diagram illustrating the interaction between IM applications and project management applications, according to one embodiment of the present invention.

FIGS. 3A, 3B, 3C and 3D are generalized block diagram illustrating data structures which may be used to transmit task and/or project information over an IM infrastructure, according to one embodiment of the present invention.

FIGS. 4A, 4B and 4C are generalized block diagrams illustrating the assignment of tasks to groups within an IM framework, according to one embodiment of the present invention.

FIGS. 5A, 5B and 5C are generalized flow diagrams illustrating the exchange of task information among a group of users, according to one embodiment of the present invention.

FIG. 6 is a generalized block diagram illustrating the use of a “widget” for handling tasks, according to one embodiment of the present invention.

FIG. 7 is a generalized block diagram illustrating the exchange of tasks among disparate IM clients on different IM networks, according to one embodiment of the present invention.

FIG. 8 is a generalized block diagram illustrating an interaction of multiple IM clients, according to one embodiment of the present invention.

### SUMMARY OF THE INVENTION

The present invention provides a method and system for facilitating the exchange of tasks over an instant messenger (“IM”) infrastructure. An IM application, running on an electronic device, may allow a user to create, assign, track, view, export, import and manage tasks. IM applications may include, but not be limited to, stand-alone applications, browser plug-ins, on-screen widgets and gadgets, PDA and cellular phone modules, server-sided applications rendered on a client machine, etc.

Tasks exchanged over IM networks may have a close tie-in to computer applications. Personal Information Management (“PIM”) applications (e.g. Microsoft® Outlook®) may use IM services and/or protocols to exchange tasks over disparate networks. Project management applications (“PMA”) (e.g. Microsoft® Project®) may be used to define projects, containing tasks with complex sets of rules and inter-dependencies, and use IM networks services and/or protocols to disseminate these projects and tasks among users. Tasks exchanged on an IM network may be imported into PMAs and PIMs.

Tasks may be exchanged in a peer-to-peer IM network spanning multiple IM service providers. Tasks may be transported in XML data structures which may contain data pertaining to users for whom tasks are intended, the progress made on tasks, documents attached to tasks, etc. User roles may be defined within tasks structures such that some users are the assignees of a task, while other users may only view task progress and be notified of milestones as tasks are worked on. Users may form task groups and communities, allowing them to control who may assign tasks to members of the group.

### DETAILED DESCRIPTION

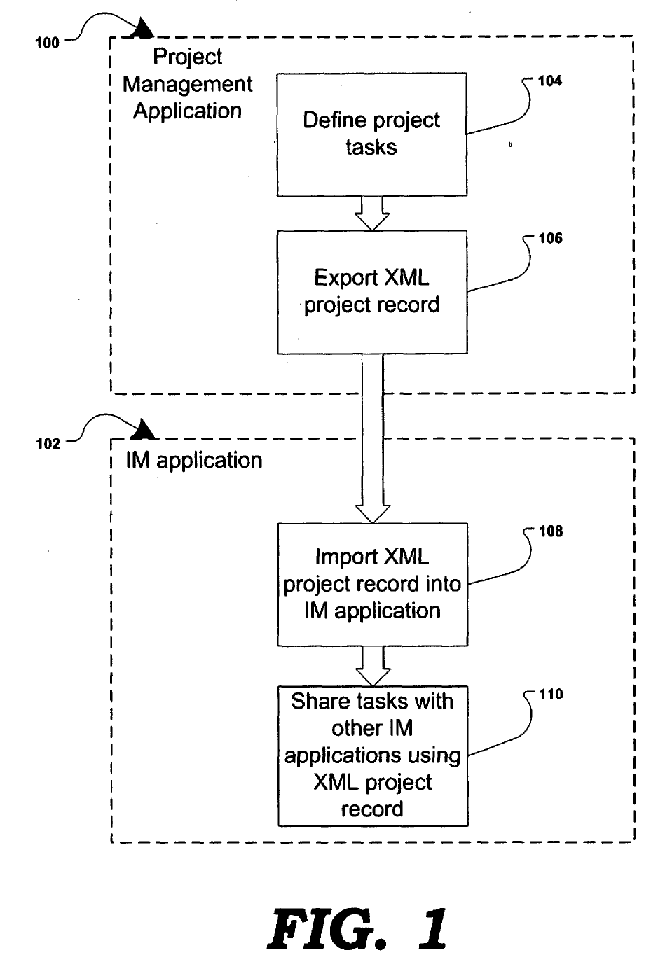

FIG. 1. is a generalized block diagram illustrating the interaction between a project management application (“PMA”) and an instant messenger (“IM”) application, according to one embodiment of the present invention. PMA 100 (e.g. GanttProject, KPlato, Open Workbench, Planner, TaskJuggler, activeCollab, dotProject, GForge, GNU Savannah, PHProjekt, Project-open, TUTOS, Trac, WebCollab, Microsoft Project, MPMM, Planisware OPX2, Primavera, CONSIM, Phoenix Project Manager, 24SevenOffice, AceProject, AtTask, Creative Manager Pro, Basecamp, Teamwork, Tenrox Project Workforce Management, Webasyst, etc.) may allow users to create projects and assign project tasks 104 to other users. The data structure or file within which PMA 100 may store information (e.g. the name of the project, the tasks assigned to individuals, the completion status of each task, etc.) and such information may be referred to as a project schema, or project record. PMA 100 may allow exporting the project record 106 of a project in a universally-understood format, such as XML (extensible markup language), making the project record portable among various applications and platforms.

IM application 102 may import 108 a project record exported from a PMA 100. Once the project record is imported, IM application 102 may share 110 projects and tasks defined in the project record, with other IM applications. In the presently-preferred embodiments of the invention, IM application 102 may import 108 a project record in, for example, XML format and parse it into its discrete project and task components. IM application 102 may then share the projects and tasks defined in the project record, with other IM applications. For example, if the project record exported 106 includes the definition of a project which contains five tasks for five different people, IM application 102 may send each task contained in the project record to the appropriate user of a remote IM application.

In another embodiment of the present invention, the exporting of PMA 100 project record(s) and/or data 106 may utilize such format as to assure the data structure of the exported file is “understood” by the specific type of IM application 102 which may later import the data. For example, a user of PMA 100 may choose from a drop down list of IM applications the desired IM application 102 which is to import the data 108, causing PMA 100 to use a proper filter to export the data 106 into a file format importable by IM application 102.

In another embodiment of the present invention, the import functionality 108 of IM application 102 may contain a filter to “understand” the format of a data file exported by PMA 100. For example, IM application 102 may enable the user to choose a data file, such as a project record, created by PMA 100, for import, whereby IM application 102 may contain the proper code to decipher and process the imported data 108.

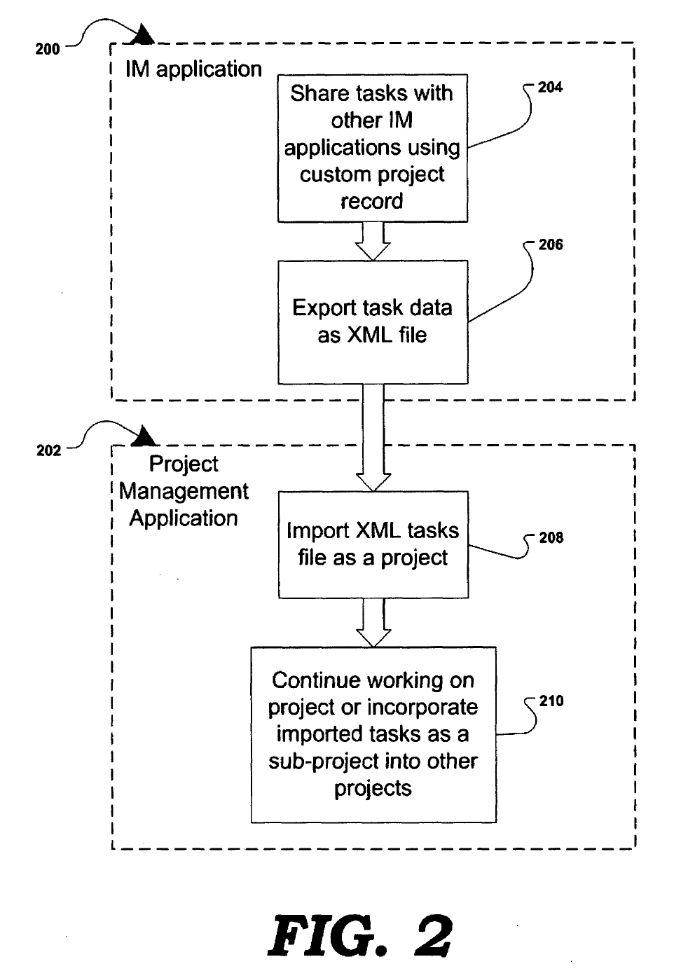

FIG. 2. is a generalized block diagram illustrating the interaction between IM an application and a project management application, according to one possible embodiment. IM application 200 may employ a custom project record defining the various tasks assigned to various remote users, as well as data associated with tasks. IM application 200 may be able to export 206 the project record and data associated with a project or set of tasks in various formats. In the currently-preferred embodiment, the project record and-data export 206 is in XML format, and may contain some or all the data associated with a project or collection or tasks, such as the description of tasks, their completion stages, the users they had been assigned to, etc.

Project Management Application 202 may have the ability to import 208 a project record and data collection, containing project and/or task data, and incorporate 210 the imported data into an existing project; or, create a new project from the imported data.

In another embodiment of the present invention, the exporting of IM application 200 project record(s) and data 204 may utilize such format as to assure the data structure of the exported file is “understood” by the specific type or embodiment of PMA 202 which may later import the data. For example, a user of IM 200 may choose from a drop down list of PMAs, the desired PMA type, or desired format 202 which is to import the data 208, causing IM 200 to use a proper filter, template or process to export the data 206 into a file format importable by PMA 202.

In another embodiment, the import functionality 208 of PMA 202 may contain a filter to “understand” the format of a data file exported by IM 200. For example, PMA 202 may enable the user to choose a data file created by IM 200, for import, whereby PMA 202 may contain the proper code to decipher and process the imported data 208.

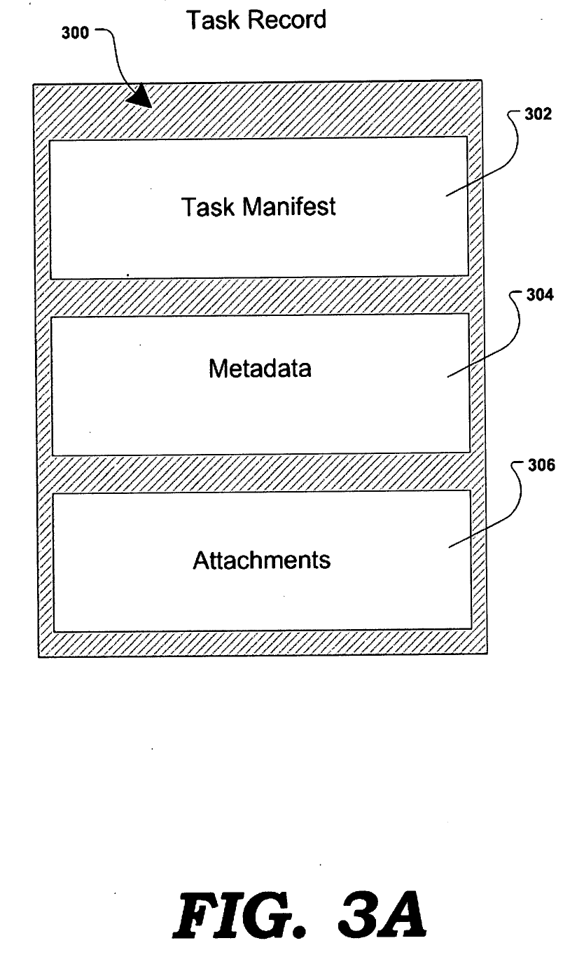

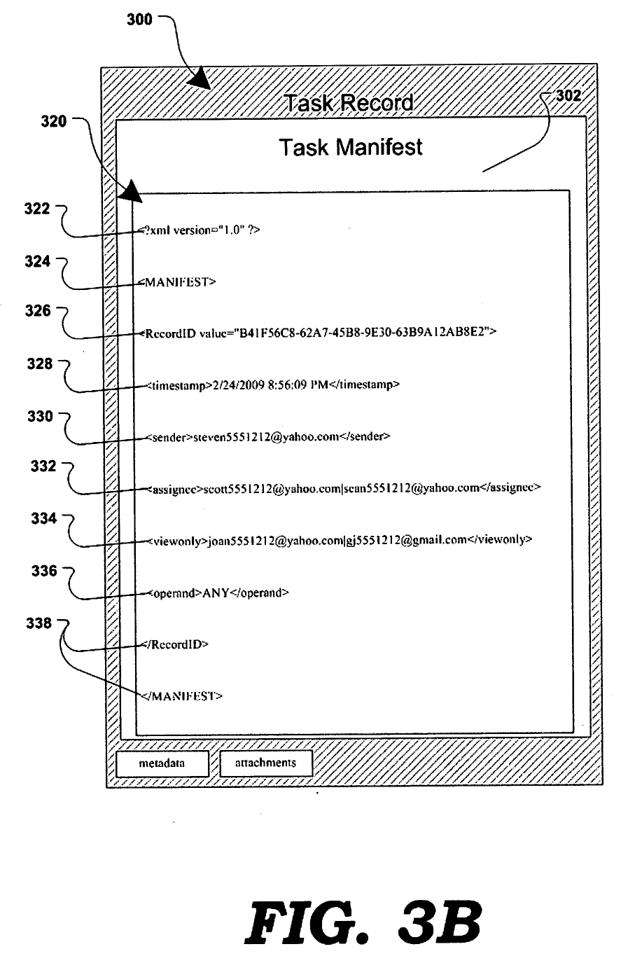

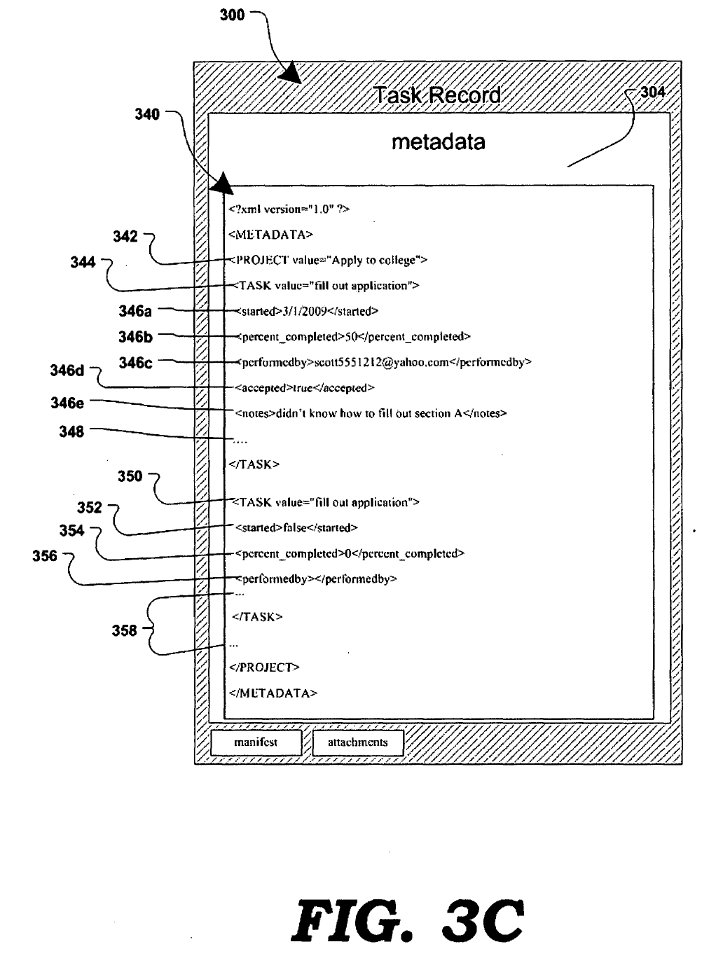

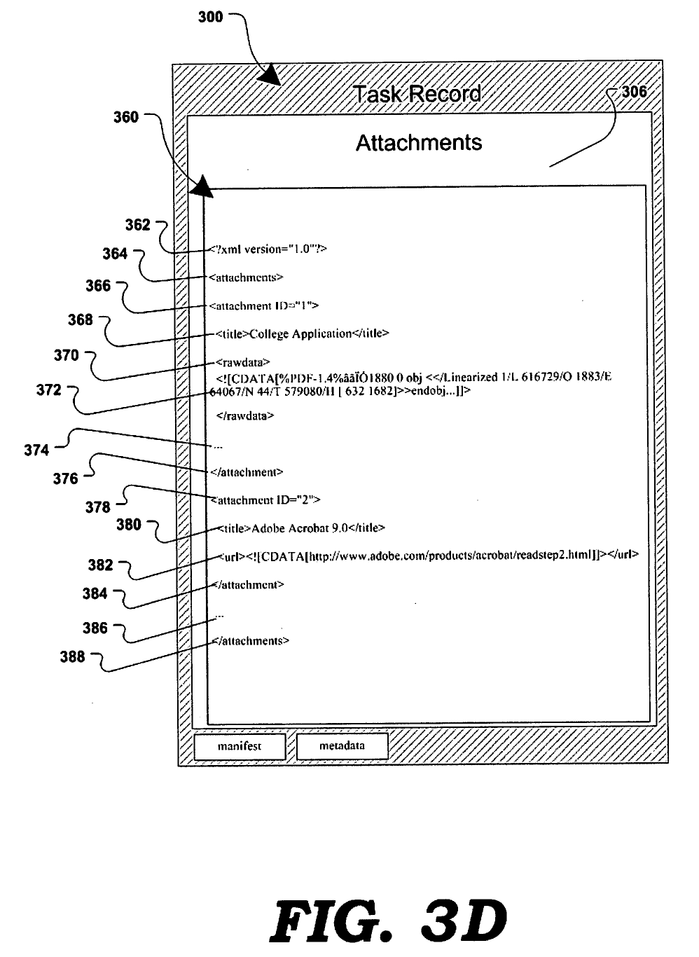

FIGS. 3A, 3B, 3C and 3D are generalized block diagrams illustrating project records which may be used to carry task and/or project information over an IM infrastructure, according to one example embodiment. Instant messaging may be decentralized, over a peer-to-peer network. Hence projects and tasks exchanged among users may preferably be self-contained. (i.e. in the absence of a central database, all task information, such as task names, completion status, users involved in tasks, etc, may need to be sent from one user to the next.)

Referring to FIG. 3A, task record 300 is one example of a data structure which may be utilized to exchange task data among IM users. Task record structure 300 may contain: a task manifest 302, metadata 304 and attachments 306. In the currently-preferred embodiment, task record 300 is in XML format with the task manifest, metadata and attachments as nested elements. Task record 300 may be sent, in its entirety—containing all information needed to track the progress of a project and all (or any subset of) associated tasks—from one user to the next. For example, a user sending a set of tasks via IM may utilize task record 300 to define the tasks and recipients, whereby the task manifest 302 may contain the names of the recipients and their roles; metadata 304 may contain task information; and attachments 306 may contain any attachments to the tasks, such as documents (for example, Word document or an Excel document, etc.), sound-files with voice instructions etc.

Referring to FIG. 3B, a task manifest section 302, containing task data 320, may be part of task record 300. Task manifest 302 may include information used to define the participants in the project/collection of tasks, and/or their roles. In the currently preferred embodiment, data 320 may be in XML format. Upon receipt of a task record 300, an IM application may read the task manifest section 302 and present information from the task manifest to its user according to the instructions in the manifest. For example, if the current user of an IM application is “gjatida@gmail.com” and the task manifest 302 instructs for this user have “view only” rights, the IM application will present the tasks to the current user as view-only and not allow the user to make changes.

Task data 320 may be in XML format, as suggested by the XML tag 322. A “manifest” tag 324 may mark the beginning of the task manifest. In consistence with XML language requirements, close tags 338 may be used to denote the end of the task manifest section within the task record 300.

A task “RecordId” attribute may have a unique value 326 to distinguish one task record from other task records a user may receive. In the currently-preferred embodiment, the task record value is a GUID (globally unique identifier) allowing for each task record 300 to be uniquely identified and differentiated from other task records exchanged.

A task data 320 may contain a date/time stamp attribute 328, indicating when the task had been create or first assigned.

A manifest data set 320 may contain a sender identifier 330. The sender identifier 330 may be a shorter version, such as “steven5551212”, identifying the user uniquely to the service provider of the IM application (in this example. Yahoo!); or, the handle may be in a longer format, such as “steven5551212@yahoo.com” in this example, identifying the user's identifier uniquely when the IM application is used across multiple IM networks (e.g. Yahoo! and Microsoft's Live Communication Server networks.) The sender identifier 330 may be an address, for example an email address or IM address, a portion or modification of an address, or may be any other combination of characters, numbers or symbols which may be used to identify a user to a person, application or service. In one presently preferred embodiment, the sender identifier 330 is the IM address of the sender.

One or more assignee attributes may be defined by the “<assignee>” tags 332. Multiple assignee identifiers may be combined into an array (e.g. delimited by a character such as the “pipe” character |). Upon receiving task record 300, an IM application may compare the name of the logged-in user with the names of the assignees 332, and display one or more tasks to the current user, if the user's identifier is included the list of assignees 332.

One or more viewing privileges attributes may be defined by the “<viewonly>” tags 334. Multiple identifiers and/or viewing privileges information may be combined into an array (e.g. delimited by a character such as the “pipe” character |). Upon receiving task record 300, an IM application may compare the name of the logged-in user with the names of the view-only users 334, and display one or more tasks to the current user, if their handle is in the list of view-only users 334. The tasks may be displayed in a manner allowing the logged user to view them and any changes made to them by other users—but not make changes. Similarly, other viewing privileges may be defined, allowing or restricting viewing any portion or status of a task or group of tasks.

An operand attribute 336, denoted by the “<operand>” tags, may be included to indicate whether any or all assignees 332 are required to mark a task, or a corresponding portion of a ask, as “complete” for the task be considered completed. In this example, the operand 336 is “ANY”, suggesting any of the assignees 332—either “scottslip@yahoo.com” or “seanslip@yahoo.com”—is required to mark a task as “complete” for the task to be considered completed, and displayed to all users as completed. Had operand 336 been “ALL”, both “scottslip@yahoo.com” and “seanslip@yahoo.com” would each need to mark a task as complete, for the task to be considered completed.

Additional attributes may be included in the task manifest 320 for controlling how tasks are handled, distributed and displayed.

Referring to FIG. 3C, a task record 300 may include a task metadata section 304, containing task data 340. In the currently-preferred embodiment, task data 340 is in XML format and contains project and task data within record 300. Task metadata section 304 may be updated by users receiving the task record 300, as users add notes to tasks or update the completion status of tasks.

Task metadata section 304 may contain one or more tasks 344 & 350, organized into one or more projects 342. In this example, the project element value (or title) 342 is “Apply to college”. Attributes 344-358 are tasks and task attributes that are part of the project 342 in this example.

Task “fill out application” 344 may contain attributes 346a-348 which are attributes of the task element 344. These attributes may be modified according to the actions performed by various users receiving the task. The “<started>” attribute 346a may be stamped with the current date/time once a user has accepted the task 344 and started working on it. A user's acceptance of the task 344 may be recorded in attribute “<accepted>” 346d, by a value such as “true”. The handle of the user performing the task 344 may be recorded in the element attribute “<performedby>” 346c. The user may indicate progress they have made on a task, which may be recorded as element attribute “<percent_completed>” 346b. Notes pertaining to the task 344 may be recorded as the “<notes>” element attribute 346e.

Additional data 348 my be added as task attributes, both as part of the original schema, and in the course of a user's executing a task. Examples of additional task attributes may include, but not be limited to: elements to track the states of sub-tasks for tasks, task reminders and notifications, task milestones, task re-assignment, unique task IDs, etc.

Multiple individual tasks 344 and 350 may be nested within a project 342. Individual tasks may be different from each other, as may be indicated by the “value” attribute of the “<TASK value=..>” tag. (E.g. <TASK value=“fill out application”></TASK> and <TASK value=“file application”>) Tasks 344 and 350 may also bear the same value, such as in cases where different individuals are assigned the same task. Attributes within each task may differ from their counterparts in other tasks. For example, the value of the “<performedby>” 346c attribute of task “fill out application” 344 is “scott5551212@yahoo.com” whereas the value of the “<performedby>” 356 attribute of task “fill out application” 350 is a blank. This may indicate that task “fill out application” had been assigned to multiple people, and while task 344 has been picked up on “3/1/2009” 346a by “scott5551212@yahoo.com” 346c and is “50% complete” 346b, task “fill out application” 350 may not have been picked up (“<started>” value is, as an example, “false” 352 and “<performedby>” 356 is, as an example, blank ) and is “0% complete” 354.

Additional elements and attributes 358 may be added as tasks and projects, both as part of the original project record, and in the course of a user's executing a task.

Referring to FIG. 3D, a task record 300 may include an “attachment” section 306, containing data 360. In the currently-preferred embodiment, data 360 is in XML format and contains all attachments to project and task data within record 300. Task attachments may include any supporting material for a task (e.g. video, audio, documents, applications, external links, etc.) Attachments may be embedded inside the XML document 360, be external to the XML document 360 and be referenced by a link, or an attachment may be both embedded inside the XML document and external to the XML document, in different embodiments or applications. For example, User A assigning User B the task of filling out a college-application-form, may choose to embed the college-application-form-file within the task record file 360, while choosing to embed only a link to the application-program required to process the college-application-form. In this example, if the college-application-form is a small “PDF” file—e.g. 200 kilobytes in length—it may save time to embed the entire document in the task record 300 such that, upon receiving the task, User B has immediate access to the college-application-form. User A may also want to provide User B with the tools for reading and modifying the college-application-form. In this example, an Adobe Acrobat Reader® application is required. Since the majority of users already have this application installed; and Acrobat Reader® is a very large application; and it is available consistently from a highly-available URL (www.adobe.com), User A may choose to only embed a link pointing User B to the aforementioned URL, should User B require Acrobat Reader®.

Attachment data 360 may be in XML format as indicated by the declaration 362, and may be defined by a pair of “<attachments></attachments>” tags 364 and 388. Attachment data 360 may include one or more “<attachment>” elements 366 and 378. Attachment elements may have unique ID values, allowing tasks to reference individual attachments by unique values. E.g. attachment element 366 may have an “ID=1” whereas attachment element 378 may have an “ID=2” value. An attachment element may have a “title” attribute. In this example, attachment ID=1 366 has title attribute “College Application” 368, and attachment ID=2 378 has title attribute “Adobe Acrobat 9.0” 380.

Attribute “<rawdata>” 370 may contain the content of an embedded file—in this example, all the bytes of data comprising a PDF file representing a college-application-document. In the currently-preferred embodiment, a CDATA section 372 (a CDATA section is a section of element content that is marked for the XML parser to interpret as only character data, not markup) may be used to contain the raw data comprising computer-interpretable source code or data. In this example, the user receiving the task may see a hyperlinked attachment, such as “College Application”. The user may click the hyperlink, causing an application associated with the type of data-file stored in the CDATA value 372, to display the data stored. (e.g. CDATA 372 data comprises an entire .pdf document and clicking the hyperlink may launch Adobe Acrobat® and display the data 372.)

Attribute “<url>” 382 may contain a link to an external resource. The user may be presented with the title of the resource (in this example, “Adobe Acrobat 9.0” 380) In the currently-preferred embodiment, a CDATA section within attribute “<url>” 382 may contain the URL (Uniform Resource Locator or the address of the resource) to the external resource described in the title 380. The user may click a hyperlink displaying the text of the title 380 “Adobe Acrobat 9.0”, causing the URL “http://www.adobe.com/products/acrobat/readstep2.html”, contained in the “<url>” 382 CDATA section, to launch. In this example, the download of the Acrobat 9.0 application may commence, allowing a user who may not have this application installed, to install it in order to access the .pdf file embedded as “<attachment ID=“1”>” 366 element.

Additional elements and attributes 746 and 376 my be added as tasks and/or projects, both as part of the original task record, and in the course of a user's executing a task. In other embodiments, a user receiving a task may be able to add new attachments to the task received. All types of attachments allowed by the operating system of a device, may be supported. This includes, but is not limited to, all types of files: documents, executables, video, audio; as well as links to all resources on the local device, and all resources accessible to the local device on a network or internet.

The enumeration of sections 302, 304 and 306 as discrete data stores within task record 300, is for illustrative purposes only. In alternate embodiments sections 302, 304 and 306 may be combined; or may be split into more sections; or other sections capturing additional information, may be added to data structure 300.

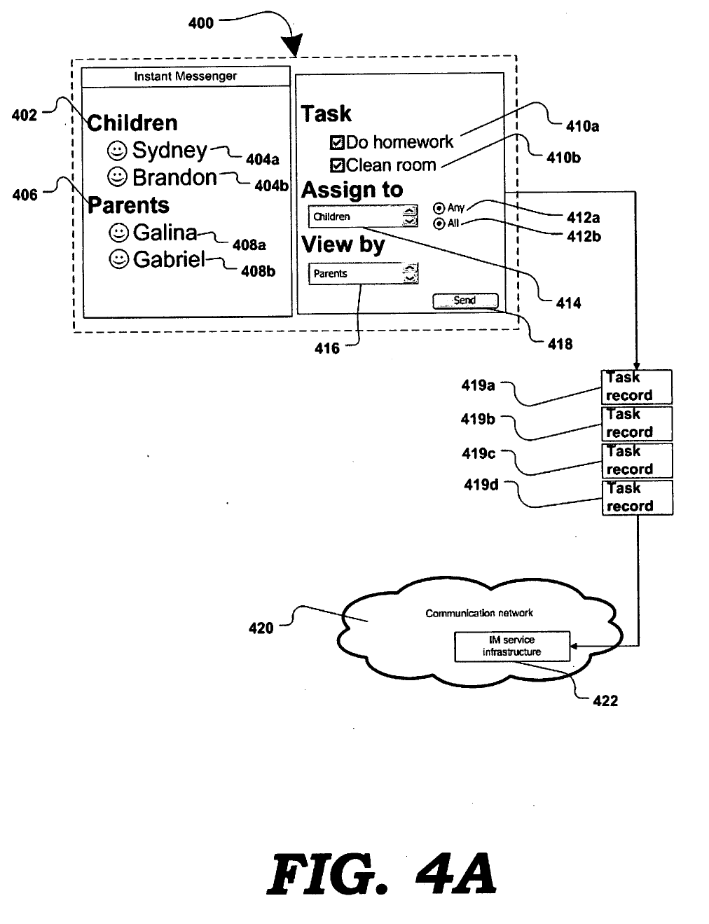

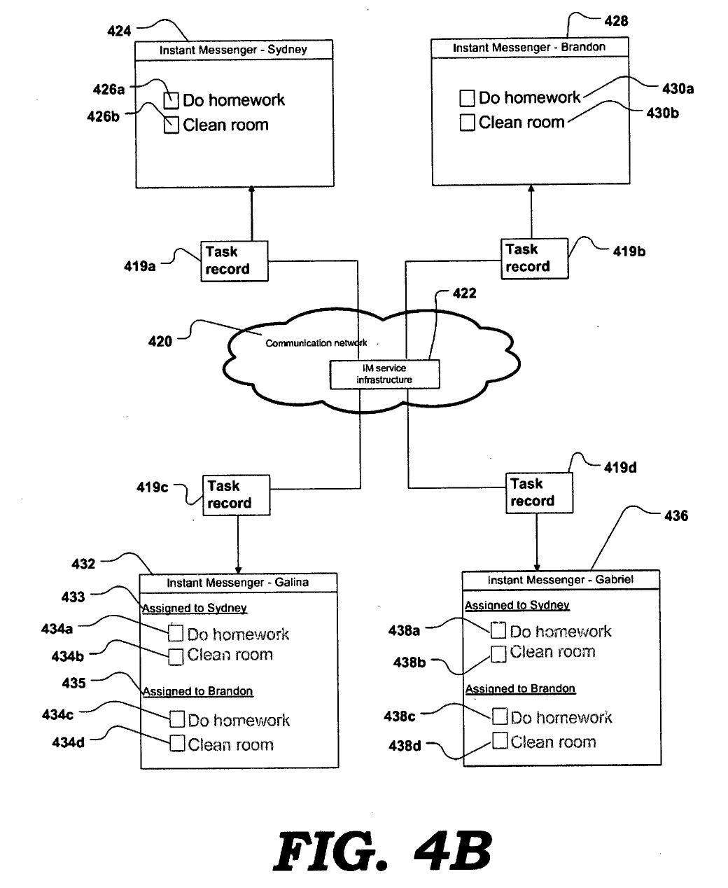

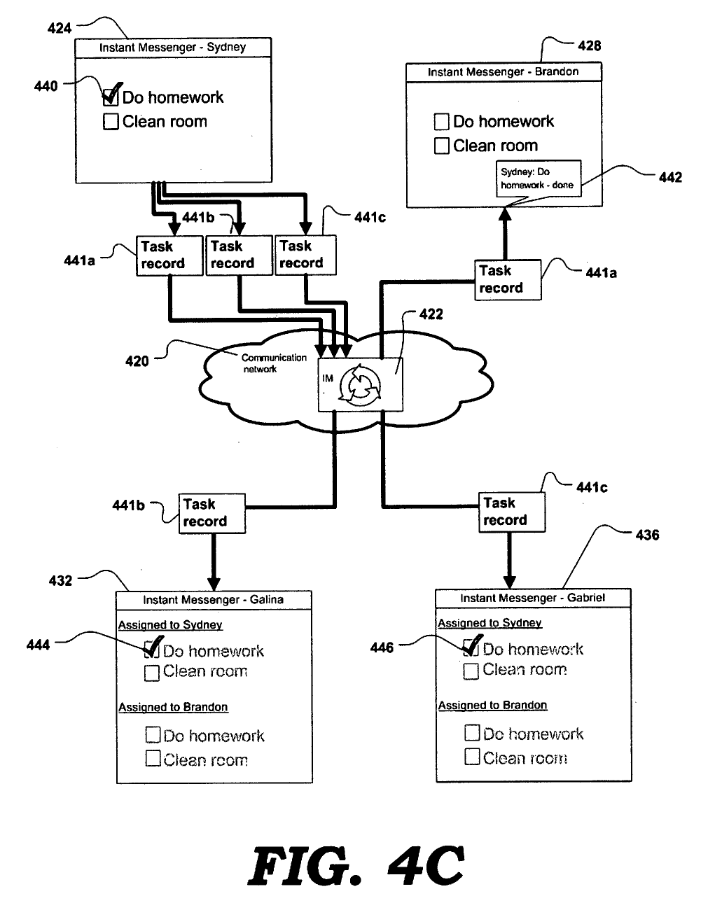

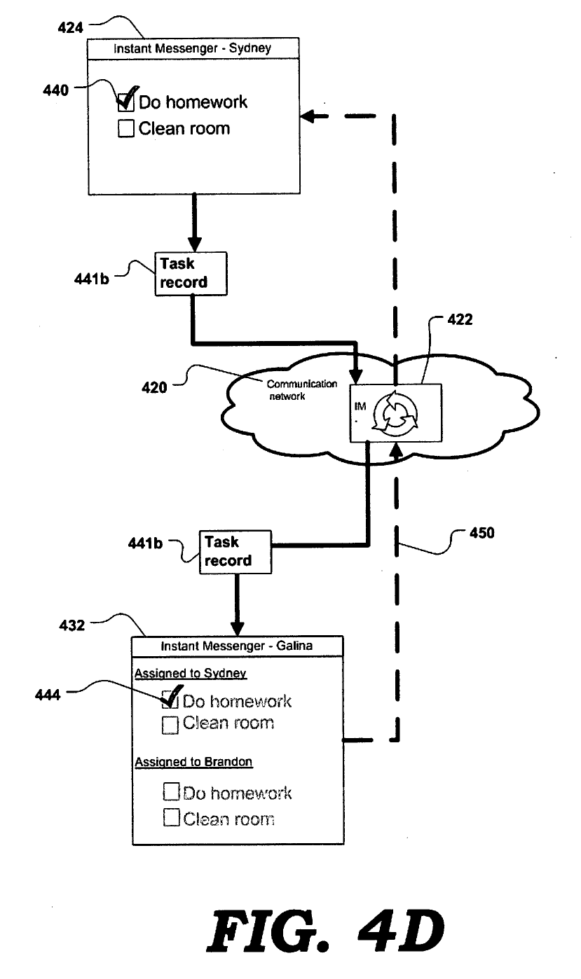

FIGS. 4A, 4B and 4C are generalized block diagrams illustrating the assignment of tasks to groups within an IM framework, according to one embodiment of the present invention. IM applications commonly contain “buddy lists” or “contact lists” (i.e. list of users who are the current user's frequent-contacts) and allow the creation of group names and the grouping of contacts into groups. Referring to FIG. 4A, IM client application 400 may contain a contact list with contact identifiers (contact identifiers may be in the form of names or handles—a handle being a name or string of characters chosen to uniquely identify a user within an online system, which may different from the name of a user) 404a, 404b, 408a, 408b of the users in the contact list. Contact identifiers 404a, 404b, 408a, 408b may be organized into any arbitrary number of groups 402 and 406. In this example, the user of IM application 400 has created two groups: “parents” 406 and “children” 402. The user may have grouped users “Sydney” 404a and “Brandon” 404b into group “Children” 402; and, users “Galina” 408a and “Gabriel” 408b into group “Parents” 406.

IM application 400 may allow the user to create and delegate tasks 410a and 410b. In the currently-preferred embodiment of this invention, control 414 may offer the user graphical means of selecting the user, or group, to whom tasks 410a and 410b should be assigned. By selecting a group “children” 402, all users 404a and 404b within the group “children” may receive the tasks 410a and 410b.

The user may choose whether any or all users 414 must complete the tasks 410a and 410b. The user may be presented with a graphical means of selecting whether “any” 412a or “all” 412b users 414 must complete the tasks 410a and 410b.

A user assigning a task may designate a user or a group of users as having “view-only” right (i.e. be able to see the tasks and monitor their progress, but not be able to make changes to a task) or a limited/restricted viewing right i.e. be able to view only certain information of the tasks, and not be able to change certain—or any—information). In the currently-preferred embodiment, control 416 may offer the user graphical means of selecting the user, or group, who may view and track the progress of tasks 410a and 410b. By selecting a group “Parents” 406, all users 408a and 408b within the group “Parents” may view tasks 410a and 410b.

In alternate embodiments, the user may drag-and-drop users and groups into “assign to” and “view by” areas of IM client 400.

A user may “send” a task (i.e. transmit the task to communication network 420 via IM service infrastructure 422) by issuing a command to the IM client 400, for example, by clicking a button on the IM client 400 labeled “Send” 418. A “send” command may cause all properties: tasks 410a and 410b, users/groups assigned-to 414, users/groups for view-only 416, “any/all” operand 412a /412b, etc.—to be aggregated into a task record 419 for transmission to communication network 420. In another alternate embodiment, delivery of tasks may be scheduled for future delivery. Tasks within a project may be sent, or delivered, at different times to different users, and tasks sending or delivery may be made conditional on one or more events, such as starting, progress, completion, lack of progress, failure to complete, failure to start of one or more tasks or projects.

In the currently-preferred embodiment, task data may be aggregated into a XML task-record structures 419a,419b,419c,419d, as defined in FIGS. 3A-3D, and transmitted over IM service infrastructure 422 to all users in the “assigned-to” 414 and “view-only” 416 fields. The task-records 419a,419b,419c,419d may be sent to every individual designated as recipient: 419a to Sydney 404a, 419b to Brandon 404b, 419c to Galina 408a and 419d to Gabriel 408b (FIG. 4A). In alternate embodiments, the task records 419a, 419b, 419c, 419d may differ from each other, with every record containing only tasks and properties specific to the recipient(s) of that task record. In yet another alterative embodiment, task records 419a, 419b, 419c, 419d may differ from each other, with some task records containing information from only tasks and properties specific to the recipient(s) of that task record, and some task records may include information on tasks assigned to other users, for example when one user may be partly responsible for the actions of another of the users assigned a task.

Referring now to FIG. 4B, four IM clients—Sydney 424, Brandon 428, Galina 432 and Gabriel 436—are shown, connected to IM infrastructure 422 over communication network 420. These four IM clients may be in different locales, on different devices, using different types of client applications, and/or may operate over different IM service infrastructures that allow cross-communication. IM clients 424,428, 432 and 436 receiving task-records 419a, 419b, 419c, 419d, respectively, may each render to their user, task-related data contained in their respective task-records.

User Sydney 424, as member of group “Children” 402, had been assigned tasks 410a and 410b (FIG. 4A). In the currently-preferred embodiment, Sydney's IM client 424 may display tasks “Do homework” 426a and “Clean room” 426b, which correspond to tasks 410a and 410b, respectively. Similarly, user Brandon's IM client 428 may display tasks “Do homework” 430a and “Clean room” 430b, after receiving and interpreting task-record 419b.

IM clients Galina 432 and Gabriel 436 may receive task-records 419c and 419d, respectively. The roles of users Galina 408a and Gabriel 408b, as members of group “parents” 406, have been defined as “view by” 416 (in FIG. 4A). Additionally, in this example, the tasks have been sent as to be completed by “all” 412b (in FIG. 4A). In the currently-preferred embodiment, IM client Galina 432 may render the tasks by user-sections 433 and 435, with every user-section showing the state of the tasks assigned to the user of the section. Tasks 434a and 434b, which may be displayed in IM 432 in the “Assigned to Sydney” section 433, may correspond to tasks 426a and 426b, respectively, displayed in Sydney's IM 424. Similarly, tasks 434c and 434d, which may be displayed in IM 432 in the “Assigned to Brandon” section 435, may correspond to tasks 430a and 430b, respectively, displayed in Brandon's IM 428.

Similarly, tasks 438a and 438b in Gabriel's IM 436 may correspond to tasks 426a and 426b, respectively, displayed in Sydney's IM 424. Tasks 438c and 438d may correspond to tasks 430a and 430b, respectively, displayed in Brandon's IM 428.

Tasks 434a-d and 438a-d may be displayed grayed-out in their respective IM clients, to denote that these tasks are “view-only”, i.e. a user may not be able to click the tasks or change their state. In alternate embodiments other graphical or textual indications may be used to indicate “view-only,” including, without limitation, highlighting, color differentiation, font differentiation, italicizing, bolding, a textual or graphical indicator of view only status, etc. In other embodiments, IM of “view-only” users 432 and 436 may display a task only once, regardless of the number of users to whom the task had been assigned. Once any user has completed the task (in the case where the operand “any” 412a had been used); or, all users have completed the task (in the case where the operand “all” 412b had been used) the task may appear “completed” for the “view-only” users 432 and 436. Indication of completion may be by any graphical or textual indications including, without limitation, highlighting, color differentiation, font differentiation, italicizing, bolding, a textual or graphical indicator of view only status, etc.

Referring now to FIG. 4C, multiple IM clients—Sydney 424, Brandon 428, Gabriel 432 and Galina 436—may be linked through IM infrastructure 422 over communication network 420. IM infrastructure 422 may be an instant messaging service provided by a single provider, such as Yahoo!®, or may represent multiple instant message providers, such as Google Talk® and AIM®, allowing users to cross-communicate. Users of IMs 424, 428, 432 and 436 may be able to exchange text instant messages, files, tasks, etc.

The user of IM Sydney 424 may designate a task as complete. In the currently-preferred embodiment, the user may check a GUI control, such as a checkbox 440 to denote the completion of a task. In the currently-preferred embodiment, in response to the designation of a task as complete by the user the IM client 424 may update task-record 419a (FIG. 4B) with the new status of the task. IM 424 may use the manifest portion of the data-record to discern the identifiers of the intended recipients of the task, and send designated recipients an updated task-record: task-record 441a to user Brandon 428, task-record 441b to user Galina 432 and task-record 441c to user Gabriel 436.

IM clients 432 and 436 may receive task-records 441b and 441c, respectively, and process the received task-record and update displayed task and/or project information. IM client 432 may process the received task-record 441b and discern that a new task has been performed by user “Sydney”. The user of IM client 432 had been designated as “view-only”; therefore, task “Do homework” 444 in section “Assigned to Sydney” may be checked-off. Similarly, IM client 436 may process its received task 441c and update the proper task 446 as checked-off.

A recipient 428 of a task 441a, who is designated as an assignee of the task (in this example, Brandon 428 is a member of the group “Children” and the group was assigned the tasks) may not be able to see, as a matter of preferred functionality, that another assignee, Sydney 424, had completed a task 440. In other embodiments, task-assignee Brandon 428 may receive a message, for example, a toaster-alert 442, indicating another user has made progress on a task. The received message may include a new task, for example in a task record, or may request the recipient respond in some way, for example by updating the status of one or more tasks, or inputting information. The response by the recipient may be sent to any user or location specified in the received message, or any user or location specified in a task record associated with one or more tasks.

In the currently-preferred embodiment, client IMs may discern whether a received task is an update to an existing task or is a new task. This determination may be based on an attribute in the task, such as the RecordID GUID-value 326 in the task manifest 302 in FIG. 3B, or other attribute. Accordingly, upon updating the task-record of an existing task, the RecordID may be kept the same, allowing recipient IMs to discern the received task as an update of an existing task.

In the currently-preferred embodiment, a change to a task attribute (example, user accepting a task assigned to them, user completing a sub-task, user adding a note to a task, etc) may automatically cause the user's IM client to generate and disseminate updated task-records to all recipients in the task manifest. In alternate embodiments, changes to a task may be cached by the user and sent out at a later time, such as upon gaining online access, or a recipient's gaining online-access or the user's pressing a control to indicate the updated task should be sent.

Referring now to FIG. 4D, an IM client 432 may send a querying message 450 to a remote IM client 424, requesting a tasks-record 441b be resent to IM 432. In alternate embodiments, IM client 432 may automatically send query messages 450 either at predetermined intervals, or in response to an event, such as loss of network connectivity. Receipt of query message 450 by IM client 424 may cause IM client 424 to re-compile task-record 441b and send it, via IM infrastructure 422, to the requesting IM client 432. In response to receiving task-record 441b, IM client 432 may re-display or update task data displayed in client 432.

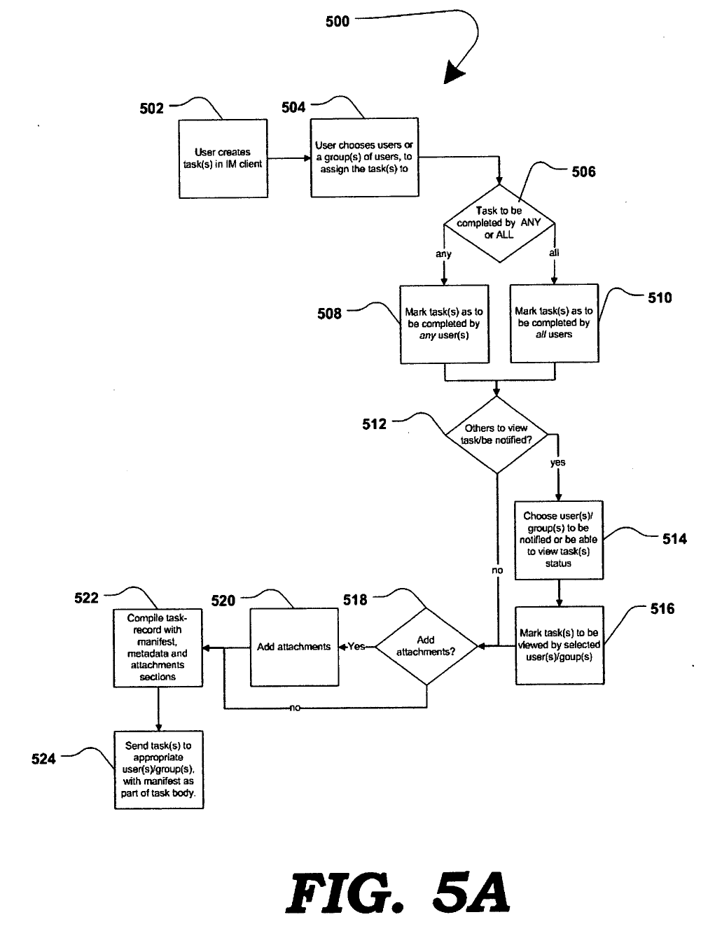

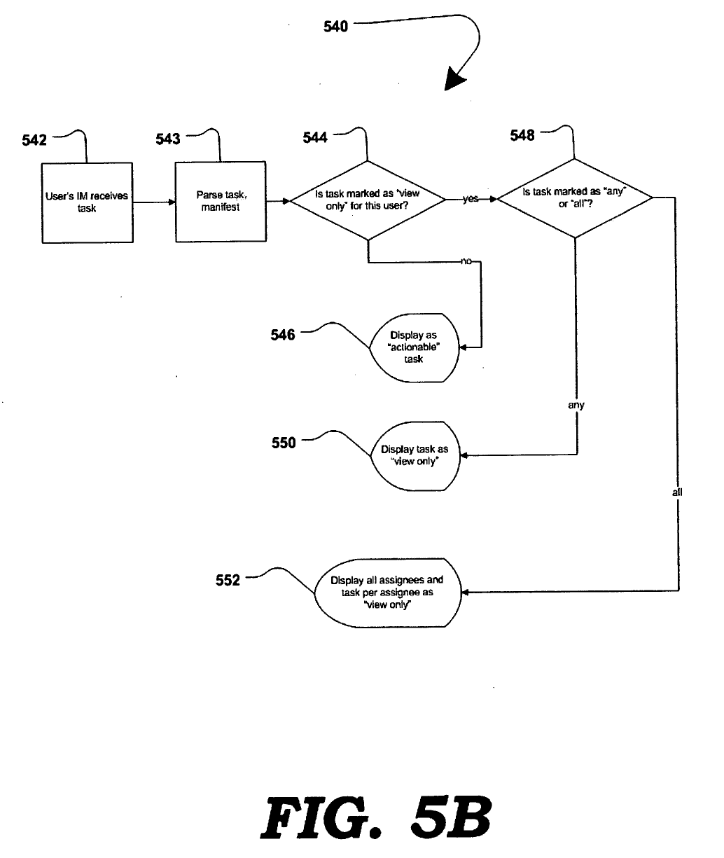

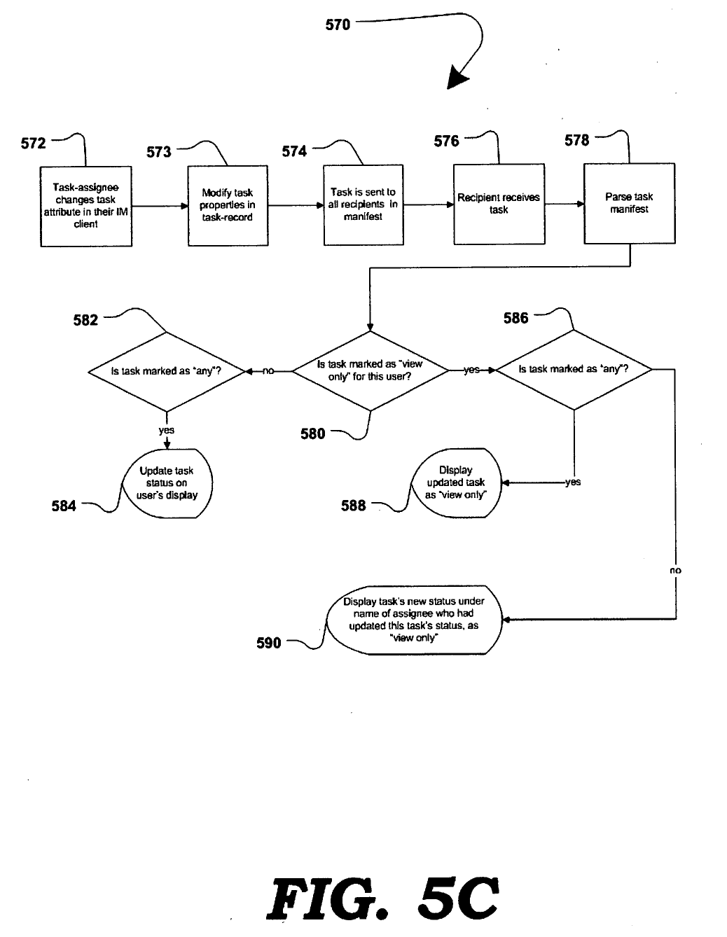

FIGS. 5A, 5B and 5C are generalized flow diagrams illustrating the exchange of task information among a group of users, according to one embodiment of the present invention. Referring to FIG. 5A, flowchart 500 illustrates the creation of a task(s) and the task(s)' assignment and dissemination to a group of users, over an IM infrastructure. At Step 502, a user may create a task, or tasks, in the user-interface of an IM client. In alternate embodiments, the user may create tasks and projects in a project management application, such as Microsoft Project®, and import the task data into the IM client. At step 504, the user may choose the individuals, or groups, to whom the task(s) will be assigned. The user may choose users or groups from among users and groups in the IM client's “contact list”; or, in alternate embodiments, the user may choose users and groups in another application—for example, Microsoft Outlook—and assign the task(s) to users and groups defined in that application.

At step 506, the user may indicate whether the task(s) should be completed by “any” or “all” users. If the user chooses the operand “any”, at step 508 the manifest portion of the task-record may be marked as “any”. The implication is that the sender of the task requires at least one of the users assigned this task to complete the task for the task to be considered completed. If the user chooses the operand “all”, at step 510 the manifest portion of the task-record may be marked as “all”. If at step 510 “all” is selected then all of the users assigned this task must complete the task for the task to be considered completed. In such an embodiment the task will not be shown as complete until all of the designated users have marked the task as complete (or until one or more users with authority to mark complete even when all users have not yet marked the task complete has so designated the task complete).

At step 512, the user may designate other individuals/groups who may be able to view the task, or be notified of task progress. The “view by” recipients of a task may view a task assigned to other users and may track the progress of the task as the assignees of the task work toward completing it. At step 514, the user may choose the individuals, or groups, to whom the task(s) will be assigned as “view by”. The user may choose users or groups from among users and groups in the IM client's contact list; or, in alternate embodiments, the user may select users and groups in another application—for example, Microsoft Outlook—and assign the task(s) as “view by” to users and groups defined in that application. In alternate embodiments users not in a contact list or other application may be entered manually, at this juncture, or at other times as needed. At step 516, the manifest portion of the task-record may be marked accordingly to include the user selected at step 514.

At step 518, the user may designate attachments that may be associated with the tasks. At step 520, the user may embed attachments or links in the task-record. The user may drag-and-drop a file (document file, executable, audio file, video file, etc.) from its original location into the IM client interface. In response, the file will be included in the task-record. The user may choose to embed links to external resources, such as links to websites and content on the internet. In such case, the link URL/URI may be embedded in the task-record.

At step 522, task-defining data aggregated in steps 502-520 (e.g. tasks, assignees, attachments, due dates, etc.) may be included in a task-record. In the currently-preferred embodiment, the task record created at step 522 has the XML structure proposed in FIGS. 3A-3D.

At step 524, the task-record created at step 522 may be sent, via an IM communication infrastructure, to the task recipients specified at steps 504 and 514.

Referring to FIG. 5B, flow chat 540 illustrates the handling of a received task-record by an IM client, according to one embodiment of the invention. At step 542, an IM client application may receive a task-record. At step 543, the manifest portion of the task record may be examined by the IM client. At step 544, the IM client may discern from the manifest of the task record, whether the user of the IM client has been assigned the role of.“assignee” or “view-only”. If it is determined at step 544 that the user of the IM client has been assigned the “view-only” role, at step 546 the task may be displayed to the user of the IM client as an actionable task. (i.e. the receiving user would see task properties and would be able to change the task properties to indicate actions they performed on the task.) If it is determined at step 544 that the user of the IM client has been assigned a “view-only” role, at step 548, it is determined whether the task operand has been set to “any” or “all”. If it is determined at step 548 that the operand is “any”, at step 550 the task may be displayed to the user as “view only” (i.e. the user may track the progress of the task but may not be able to modify it.) If it is determined at step 548 that the operand is “all”, at step 552 the task may be displayed under the name of the assignee of the task, and may not be modifiable by the user of the IM client.

Referring to FIG. 5C, flow chart 570 illustrates the handling of a user-task-assignee's changing the status of a task, according to one embodiment. At step 572, the assignee of a task may change any of the attributes of a task, e.g. mark a task as complete, in the client of their IM application, in associated module, or in an associated task or project application. At step 573, properties and attributes in the task-record may be changed to reflect the new status of the task. (e.g. the task metadata section may be updated with the status of the task as “closed” and the completion timestamp may be recorded.) At step 574, the modified task-record may be sent to the users listed in the task manifest, both as assignees and as viewers, over an IM communication infrastructure.

At step 576, a recipient may receive the task record sent at step 574. At step 578 the recipient of the task may examine the manifest of the task-record to discern their role (e.g is the recipient required to execute on the task or to only be notified on changes to the task made by other users, etc. ) At step 580 it may be determined whether the task has full access rights or more limited access rights for the recipient of the task. For example, if the task had not been designated “view only” for the current recipient, at step 582 it may be determined whether the task had been designated as to be executed by “any” user. If it is determined at step 582 the task had been designated as to be executed by “any” user, at step 584 the updated task status may be displayed to the current user.

If it is determined at step 580 the task had been designated as “view only” for the current user, at step 586 it may be determined whether the task had been marked as to be completed by “any” user. If at step 586 the task is found to have been marked as “any”, at step 588 the task may be presented, in its updated state, to the current users, as a view-only task. Alternatively or additionally, the current user may be notified of the changed state of the task. If at step 586 the task is found to have not been designated as “any”, at step 590 the task may be displayed to the current user, in its updated state, under the list of tasks assigned to the assignee who had sent this updated task. Alternatively or additionally, the current user may be notified of the updated state of the task. Similarly, other access rights such as partial view rights, partial modification rights, may also be determined and the appropriate response taken in displaying and/or allowing modification of task information.

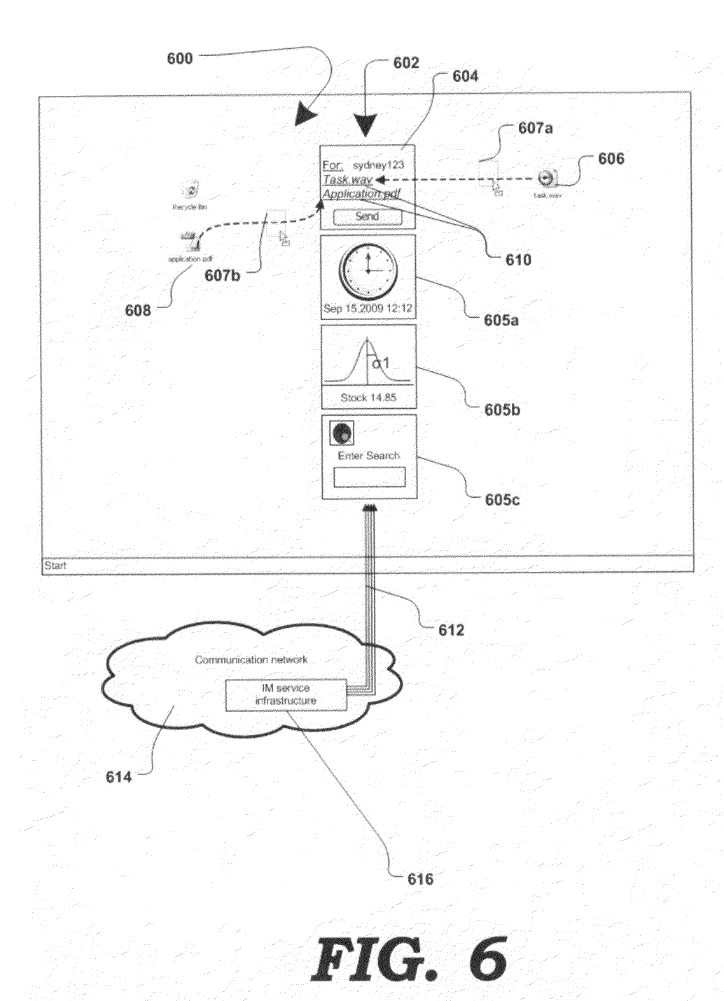

FIG. 6 is a generalized block diagram illustrating the use of a “widget” for handling tasks, according to one embodiment of the present invention. Widgets, or gadgets are small computer applications, typically residing on a user's desktop, that perform a variety of functions and are hosted by an application—or “engine”—which acts as an interface between the widgets/gadgets/plug-ins (“widgets”) and the operation system of the user's device. The desktop 600 of a user device's may contain an application 602 (e.g. Yahoo!® Widget Engine or Google® Desktop/Sidebar, etc.) capable of hosting widgets (e.g. a clock 605a, a stock ticker 605b, a search widget 605c, a task-enabled-widget 604, etc.) Task-enabled widget 604 may communicate 612 with remote task-enabled applications over an IM infrastructure 616 (e.g. Google Talk® or Yahoo! IM) on a network 614, such as the world-wide web.

Task widget 604 may receive tasks from remote users, display received tasks, allow the user to denote progress on executing the tasks; and, track the progress of other users as they execute tasks. Task widget 604 may also allow the user to create tasks, create users and groups for task assignment and viewing, delegate tasks to remote users and monitor delegated task progress.

In the currently-preferred embodiment, task widget 604 may allow the user to embed file objects 610 in tasks defined within task widget 604. File objects 610 may be of any file-type generally supported by the device of the task recipient, including, but not limited to files containing audio, video, word processing, financial data, graphics, emails, etc. For example, the user may record a voice instruction into a sound file, “task.wav” 606 on the user's desktop (or any other location accessible to the user's device.) Sound file 606 may contain a voice instruction such as “Sydney, please fill out the attached application and send it via FedEx no later than tomorrow. Call me if you have any questions.” Sound file 606 may be dragged-and-dropped 607a into task-enabled widget 604 and incorporated into tasks sent to remote user “sydney123”. Other file types, e.g. Adobe Acrobat® file “application.pdf” 608, may be dragged-and-dropped 607b into widget 604 and sent as part of a task. In this example, the user receiving the task may play the sound file “task.wav” to listen to the instructions, and then open the attached pdf file 608 to fill out the application. In alternate embodiments, the user may be provided with additional means of incorporating objects 610 into a task widget 604, for example a file section dialog box, or other graphical or textual interface for assigning an object with a task may be used.

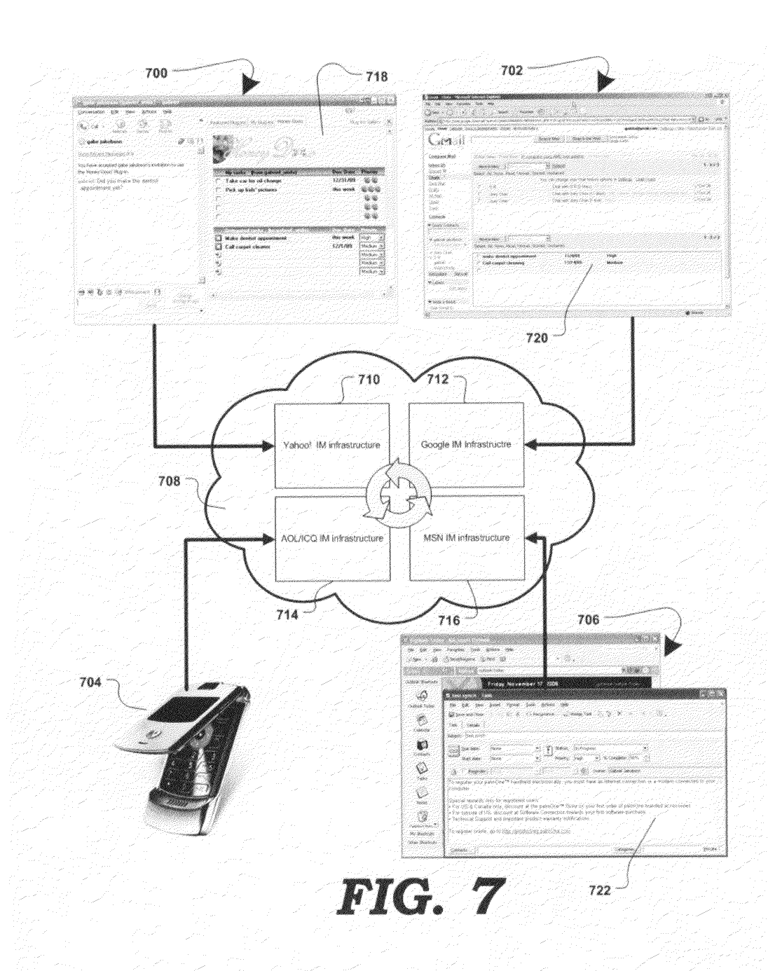

FIG. 7 is a generalized block diagram illustrating the exchange of tasks among disparate IM clients on different IM networks, according to one embodiment of the present invention. IM clients, operating on different IM networks (e.g. GoogleTalk®, MSN®, Yahoo!® IM, AOL®, etc.) and running on various devices (e.g. personal computer, cell phone, PDA, etc.) and in various interfaces (e.g. as part of an email application, as a stand-alone client application, etc.) may exchange task information among themselves.

Yahoo!® IM chat client 700 may contain a task-enabling plug-in 718, allowing the user to assign tasks to, and receive tasks from, remote users over Yahoo!® IM infrastructure 710.

Internet browser application 702 may display Google's GMail® interface, which may contain a task-enabling functionality 720. GMail® allows users to access their email and chat with remote users via the GoogleTalk® IM infrastructure 712. Gmail® may also allow users to send and receive tasks via GoogleTalk® IM infrastructure 712. Task-enabling module 720 may be displayed within the GMail® interface. In alternate embodiments, task module 720 may be an ActiveX control within browser 702, or a plug-in into GMail®, or any type of web object or a component rendered off of a remote server. Tasks module 720 may display tasks associated with all users in GMail's “quick contacts” list (list of users with whom the current user had communicated via email or chat). Alternatively, the user may choose to display tasks associated with a specific remote user—e.g. a remote user whose name has been highlighted or selected by the current user, or whose email has been opened by the current user.

A mobile device 704, such as a cellular phone and/or PDA, may be used to communicate with an IM infrastructure 714, such as AOL/ICQ. Mobile device 704 may allow the user to send, receive and track tasks, over IM infrastructure 714. An IM task module, or PIM application on the IM phone may interoperate with an IM client, or with IM infrastructure, to receive, view, create, track or modify tasks or task information.

An email and personal information management (“PIM”) software 706, such as Microsoft Outlook@, may allow a user to exchange tasks with remote users, via IM infrastructure 716 (in this example, MSN or a LCS-based IM). Tasks received from remote users may be incorporated into the user's task module 722 in the PIM application 706. The user may use PIM application 706 to assign tasks to remote users, track the execution of tasks by remote users, receive tasks from remote users, execute on the received tasks and update remote users as to execution progress.

Tasks may be exchanged among the IM services 710, 712, 714 and 716. Existing (or modified or new) communication protocols (e.g. SIP/SIMPLE, XMPP, etc.) and IM clients that are able to communication with multiple IM services (e.g. iChat, Trillian, Gaim, Fire, Proteus, Miranda IM, Adium, Everybuddy, Ayttm, Kopete, Centericq, BitlBee, Windows Messenger, IMVITE, etc.) allow users connected to one service to exchange information with users using other services. Users using an IM client connected to one service (e.g. Yahoo!'s IM service infrastructure 710) may be able to exchange tasks with users using clients connecting to other IM infrastructures and services (e.g. Google® 712, AOL® 714, MSN® 716, etc.)

In the example embodiments, various interfaces and devices are shown supporting specific IM infrastructures, for illustrative purposes only. Tasks accessed over the Yahoo!® IM infrastructure 710 are shown in a plug-in 718 to Yahoo!® IM client 700; however, Yahoo!® IM infrastructure 710 may also be accessed through any other interface or device capable of transmitting tasks over Yahoo!® IM service 710. (e.g. a Yahoo!® email browser supporting tasks, a cell phone with a Yahoo!® IM interface, a PMI application, PDA, etc.) Similarly, Google® IM infrastructure 712, AOL® IM infrastructure 714, MSN® IM infrastructure 716 (and any other IM service) may all be accessed by any interface or device supporting the exchange of tasks over these IM services, and may be capable of exchanging tasks across the varied services and platforms.

In the presently preferred embodiment of this invention, the mechanics of routing a task through various servers, networks, services and infrastructures are transparent to the users sending and receiving tasks. A user may select, designate, or type, the identifier of a remote user and assign that user a task, and the assigned task may be delivered even if the user is using a different IM client or IM service.

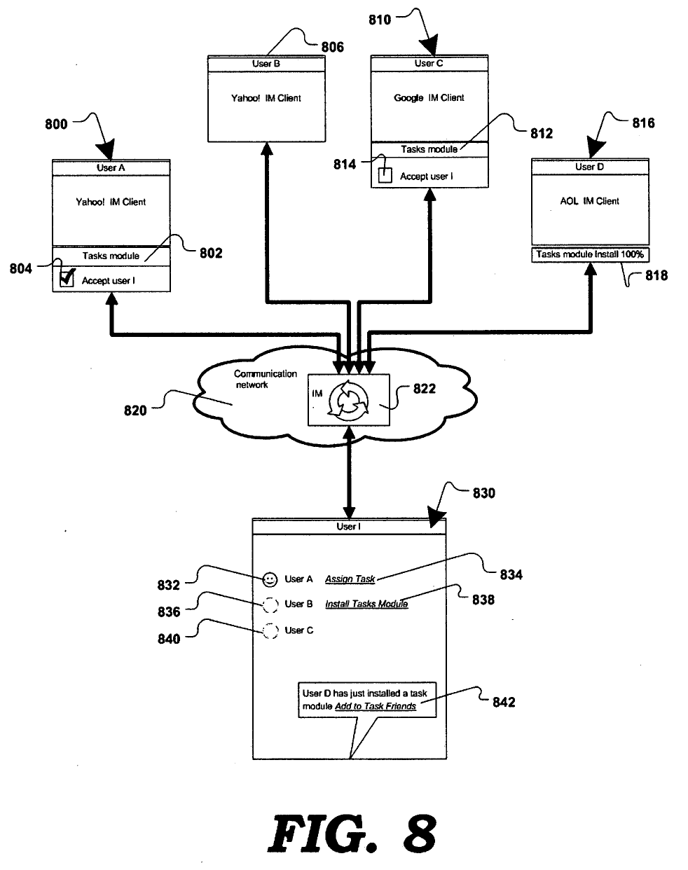

FIG. 8 is a generalized block diagram illustrating an interaction of multiple IM clients, according to one embodiment of the present invention. Users may use IM clients of different services: User A on Yahoo! IM clients 800, User B on Yahoo! IM client 806, user C on Google IM client 810, User D on AOL IM client 816 and User I on an unspecified IM client 830. The IM clients may communicate over a communication network 820, via one or more IM services/servers/infrastructures 822. IM clients 800, 806, 810, 816 and 830 may exchange task information over communication network 820. IM clients may be configured to “broadcast” their state to other IM clients (i.e. may make their state, such as on-line/off-line, known to other users.)

IM clients may make their readiness to accept tasks from various remote users, known to the remote users (in one alternate embodiment a user may configure their IM client, IM task module, or PIM device to communicate its ability or preference for receiving tasks to other users or selected groups of users). User A's IM client 800 may include an tasks-module 802, enabling IM client 800 to exchange tasks via IM. The installed-state of tasks-module 802 in IM client 800 may be communicated, via IM infrastructure 822, to User I's IM client 830. IM client 830 may provide a graphical indication to User I that User A's IM 800 is capable of accepting tasks. Such indication may be in the form of an icon (e.g. a “smiley face” or a task specific icon 832) next to User A's name; and, may include a hyperlink 834 (or button) to assign a task to User A with a single click.

An IM client 806 may not communicate, via IM infrastructure 822, its ability to receive tasks to other IM clients or IM applications. Such an IM client may or may not be capable of receiving IM task information. To indicate the uncertainty of the user receiving the task, IM client 830 may display a graphical indication by the name of User B (IM client's 806 user) that tasks may not be received (e.g. via a “grayed-out smiley face” icon or task-specific icon.) In another embodiment, a send request install task module hyperlink 838 (or button) may be displayed next to the name of the user who is unable to receive tasks. Pressing hyperlink “Install Tasks Module” 838 may send a text message to IM client 806, containing the location from which a tasks module may be downloaded or installed, and the message may include a request that the user install the identified task module. Additionally, the link sent may be chosen to correspond to the type of task module compatible with the IM client 806, or a compatible task module may be selected when the computer with IM client 806 connects via the received install task module link.

In another embodiment of the present invention, the user of an IM client may indicate which remote users may be able to assign tasks to him/her. User A's IM client 800 may contain tasks-enabling module 802 and a means of indicating 804 tasks may be accepted from User I 830 (e.g. a checked checkbox 804 with the name of the user whose tasks may be accepted.) User I 830 may receive visual indication that User A's IM client 800 is ready to receive tasks, via visual indicators such as a smiley face 832 and a hyperlink to assign a task 834. User C's IM client 810 may contain a task-enabling module 812 and a means of indicating 814 tasks may not be accepted from User I. (e.g. an un-checked checkbox 814 with the name of the user whose tasks may not be accepted.) User I 830 may receive visual indication User C's IM client 810 is not ready to receive tasks, via visual indicators such as a grayed-out/inactive smiley face 840 and lack of a hyperlink to assign a task to User C. In addition to the example smiley-face indicators discussed above, alternate embodiments may provide task specific icons to indicate a task related status of a user, their IM client, IM task module, or associated task application (such as a PIM).

In another embodiment, a user of an IM client 830 may receive a visual indication 842 that a remote user 816 has installed a tasks-enabling module 818 and may be ready to receive tasks. The visual indication may be in the form of a toaster alert 842, shown within IM module 830 or at any location on the user's desktop. The indicator 842 may be accompanied by an audible alert and may contain various information.

The features described in FIG. 8 may allow organization of users into task groups and may allow users and groups to manage projects more effectively.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

What is claimed is:

1. A method of exchanging tasks in a computer system, comprising:
connecting a task management program to an IM service; and
transferring a task record to said IM service, the task record associated with at least one IM address, the IM address associated with a user assigned a task.

2. The method of claim 1, wherein the task record includes an XML document, the XML document specifying the assigned user, the assigning user, and at least one task.

3. The method of claim 1, wherein the task record includes privilege information, the privilege information specifying the viewing rights of at least one task.

4. The method of claim 1, further comprising:
receiving task privilege information,
determining viewable task information which may be viewed with the received task privilege information; and
including the determined task information in the task record transferred to said IM service, wherein task information not determined viewable is excluded from the task record transferred to said IM service.

5. The method of claim 1, wherein the task record includes information specifying at least one attachment.

6. The method of claim 5, wherein the information specifying at least one attachment includes a link to a location where at least one document may be retrieved.

7. The method of claim 1, wherein the task record includes at least one attachment.

8. The method of claim 7, wherein the attachment is a document for use with office productivity application.

9. A method of presenting task information, comprising:
receiving a task record from an IM service;
parsing the task record to determine task information associated with an IM address; and
presenting the task information associated with said IM address.

10. The method of claim 9, further comprising:
determining task information which may be viewed by said IM address; wherein task information not determined viewable is excluded from the presenting of the task information associated with said IM address.

11. The method of claim 9, wherein the presentation of the task information associated with said IM address is performed by a plug-in associated with an IM client associated with said IM address.

12. The method of claim 9, wherein the presentation of the task information associated with said IM address is performed by an IM client associated with said IM address.

13. The method of claim 9, wherein the presentation of the task information associated with said IM address is performed by a task management application associated with said IM address.

14. The method of claim 9, wherein the task record is an XML file.

15. The method of claim 9 further comprising:
determining which application the task information is to be presented in, wherein presenting the task information associated with said IM address is presented in the determined application.

16. The method of claim 15, wherein the application the task record is to be presented in is specified by a user associated with the IM address associated with the task to be presented.

17. The method of claim 9, further comprising:
receiving task completion indication;
creating a task completion record, the task completion record including information on at least one completed task; and
transferring the task completion record to said IM service.

18. The method of claim 17, wherein the task completion record is transferred to the IM service for transfer to an IM completion notification address, the IM completion address associated with the task included in the task completion record.

19. A method of transferring tasks between a plurality of users, comprising:
selecting at least one task for transfer;
retrieving at least one IM address associated with at least one user;
creating a task record, the task record including the at least one task selected for transfer;
associating the task record with the at least one retrieved IM address; and
transferring the task record to said IM service.

20. The method of claim 19, comprising:
prior to creating the task record, determining whether the task is to be transferred over an IM service, and in the event the task is to be transferred over a given IM service, selecting a task record format associated with exchange over the given IM service.

21. The method of claim 20, wherein the task record format associated with exchange over the IM service is an XML format.

22. The method of claim 19, further comprising:
determining whether one or more tasks has been completed;
in the event one or more tasks has been completed, retrieving at least one IM address associated with the at least one completed task;
creating a task completion record, the task completion record including information on at least one completed task; and
transferring the task completion record to said IM service for delivery to at least one IM address associated with the at least one completed task.

23. The method of claim 19, further comprising:
extracting task information from a received task record; and
registering a task in the first task management program, the task included in the extracted task information.

24. The method of claim 19, further comprising:
receiving task accepting information from an IM client associated with the at least one retrieved IM address; and
presenting an indication of task accepting of the at least one retrieved IM address according to the received task accepting information.

25. The method of claim 24, further comprising:
in the event the event the received task accepting information indicates the IM client associated with the at least one retrieved IM address is not ready to accept tasks, sending the IM client associated with the at least one retrieved IM address a request to install a task accepting program.

26. The method of claim 25, wherein the request to install the task accepting program includes a link to download the task accepting program.

27. The method of claim 26, wherein the task accepting program is a plug-in for an IM client.

28. The method of claim 19, wherein the at least one retrieved IM address is associated with a group, and wherein the at least one retrieved IM address is retrieved in response to the selection of a group.

29. The method of claim 28, wherein the group is associated with a project in a project management application.

30. A method of synchronizing task information, comprising:
sending a task synchronization query to at least one other task application via an IM service;
receiving a task synchronization response message from said at least one other task application via an IM service; and
in the event the task synchronization response message indicates at least one task is not in synchronization, sending a task record including updated task information on the at least one task is not in synchronization to the said at least one other task application via an IM service.
